(19) United States
(12) Patent Application Publication
(10) Pub. No.: US 2025/0156225 A1
(43) Pub. Date: May 15, 2025

(54) STORAGE DEVICE SWAP IN A MULTIPLE COMPUTING CLUSTER ENVIRONMENT BASED ON PEER-TO-PEER REMOTE COPY STATE CHANGE

(71) Applicant: INTERNATIONAL BUSINESS MACHINES CORPORATION, ARMONK, NY (US)

(72) Inventors: TARIQ HANIF, LAGRANGEVILLE, NY (US); TABOR R. POWELSON, POUGHKEEPSIE, NY (US); TRANG THUY LE, SAN JOSE, CA (US)

(21) Appl. No.: 18/507,745

(22) Filed: Nov. 13, 2023

(51) Int. Cl. G06F 9/50

(52) U.S. Cl. CPC G06F 9/5016; G06F 9/5072

(57) ABSTRACT

Storage device swap in a multiple computing cluster environment based on peer-to-peer remote copy state change includes detecting that a peer-to-peer remote copy (PPRC) state change event has occurred on a first storage device shared across a plurality of computing clusters. A first computing cluster of the plurality of the plurality of computing clusters determines that the PPRC state change event was not caused by the first computing cluster. A swap event to swap from usage of the first storage device to usage of a second storage device shared across the plurality of computing clusters is initiated responsive to the determining that the PPRC state change event was not caused by the first computing cluster.

### BACKGROUND

The present disclosure relates to methods, apparatus, and products for storage device swap in a multiple computing cluster environment based on peer-to-peer remote copy state change.

### SUMMARY

According to embodiments of the present disclosure, various methods, apparatus and products for storage device swap in a multiple computing cluster environment based on peer-to-peer remote copy state change are described herein. In some aspects, storage device swap in a multiple computing cluster environment based on peer-to-peer remote copy state change includes detecting that a peer-to-peer remote copy (PPRC) state change event has occurred on a first storage device shared across a plurality of computing clusters. A first computing cluster of the plurality of the plurality of computing clusters determines that the PPRC state change event was not caused by the first computing cluster. A swap event to swap from usage of the first storage device to usage of a second storage device shared across the plurality of computing clusters is initiated responsive to the determining that the PPRC state change event was not caused by the first computing cluster.

### BRIEF DESCRIPTION OF THE DRAWINGS

FIG. 1 sets forth an example computing environment according to aspects of the present disclosure.

FIG. 2 sets forth another example computing environment according to aspects of the present disclosure.

FIG. 3 sets forth a flowchart of an example process for state change interrupt processing according to aspects of the present disclosure.

FIG. 4 sets forth a flowchart of an example process for peer-to-peer remote copy summary unit check processing according to aspects of the present disclosure.

FIG. 5 sets forth a flowchart of an example process for swap service initiation according to aspects of the present disclosure.

FIG. 6 sets forth a flowchart of an example process for storage device swap in a multiple computing cluster environment based on peer-to-peer remote copy state change according to aspects of the present disclosure.

FIG. 7 sets forth a flowchart of another example process for storage device swap in a multiple computing cluster environment based on peer-to-peer remote copy state change according to aspects of the present disclosure.

### DETAILED DESCRIPTION

A computing system is often in communication over a network with one or more storage systems for storing and accessing data used during operation of the computing system. The different storage systems are often located in different geographical locations. Each storage system typically includes one or more storage devices (e.g., disk drives) controlled by a storage controller. Storage replication allows for maintaining redundant copies of data on two different storage systems to allow for continuous availability in the event of a failure of one of the storage systems. Switching from usage of one storage system to another storage system is often referred to as a swap event. The switching from one storage system to another storage system in the event of a failure of the storage system is often referred to as an unplanned swap event. An example of an operating system including such swap capability is the HyperSwap function provided by the z/OS operating system offered by International Business Machines™. A sysplex refers to a computing cluster of independent instances of an operating system. The HyperSwap function provides for continuous availability in the event of disk failures by maintaining synchronous copies of all primary disk volumes on one or more secondary storage controllers. During data replication, data is copied from a source volume to one or more target volumes. The source volume and target volumes that contain copies of the same data are collectively referred to as a copy set. Disk failures can be hidden from applications by the HyperSwap function automatically swapping form one set of disk volumes to another as a result of triggering a swap event.

Peer-to-peer remote copy (PPRC) is a protocol used to replicate a primary storage volume to a secondary storage volume. The primary storage volume and secondary storage volume are often connected together through a communication link called a PPRC path. To facilitate configuration of storage devices, a storage device partitions its possible logical volumes into groups of volumes. Each group of volumes is referred to as a logical subsystem (LSS). An LSS is uniquely identified within the storage system by an LSS identifier that typically is a numerical value. To establish remote mirror and copy pairs, a logical path is established between the associated LSS pair.

In a swap environment (e.g., a HyperSwap environment) with storage devices shared across multiple computing clusters (e.g., sysplexes), a need exists for each computing cluster to be aware when another computing cluster has swapped. This need especially exists for a system which allow each computing cluster to utilize independent swap sessions, and/or each swap session is on a sysplex basis which communicates with each other only through the shared storage devices. In existing procedures when one session/sysplex swaps, the other session/sysplex is triggered to swap by the first session soft fencing the shared devices, receives a soft fence unit check, and automatically swaps. Soft fencing prevents unintended access to the storage device by preventing most I/O operations (e.g., reading and writing data) to the storage device.

However, if there is no or little I/O activity on the shared storage device, the swap may not occur immediately. For example, if I/O activity to some other non-HyperSwap protect device is hanging, an application that normally performs I/O operations to shared devices may be delayed. A disadvantage of delayed swapping may include, for example, an undesirable user experience caused by confusion regarding the delayed swap. Another example of a disadvantage that may occur due to a delayed swap is that it can expose existing or new timing windows, e.g., if a second sysplex is down before swapping, a mix of PPRC primary and secondary devices within their configuration may require manual intervention to repair. Another potential disadvantage of delayed swapping is that a user may be unable to initiate cleanup activities such as restarting mirroring from a second storage site to a first storage site until all sysplexes have swapped to the second storage site.

One or more embodiments provide for a method of automatically swapping of storage devices in a multiple computing cluster environment based on peer-to-peer remote copy (PPRC) state changes of a foreign computing cluster. In a particular embodiment, swap event processing occurs when a PPRC state change event is raised either through (1) an attention event in which case a data facility storage management subsystem (DFSMS) component of an operating system of a sysplex issues a Senses Subsystem Status command to determine the new PPRC state for a storage device; or (2) a PPRC summary event unit check in which case the DFSMS component issues a Query Storage Controller Status to determine the new PPRC status for all devices in a LSS. In either case, the DFSMS component uses the results of either the attention event or the summary event unit check to determine if the PPRC state changed from a duplex secondary state to a suspended primary state. In this case, the storage device in the duplex secondary state is the only operative volume of the pair and the storage device in the suspended primary is currently non-operational. If the PPRC state changed from a duplex secondary state to a suspended primary state, an operating system (e.g., an IOS) service is called to determine if an unplanned swap event should occur. The operating system service determines if the event should be active upon and performs filtering of the event status before obtaining any module resources. In a particular embodiment, the operating system service utilizes a HyperSwap data structure to determine a corresponding PPRC primary storage device for a pair. If the system is not already undergoing a swap, implying that the swap trigger is from a foreign sysplex, and if the current sysplex is HyperSwap capable, the current sysplex raises an unplanned HyperSwap Event Notification signal to initiate a swap operation.

In one or more embodiments, a method for immediately performing a swap event in a storage replication environment with multiple computing clusters (e.g., sysplexes) sharing storage devices includes detecting, by a computing cluster, a PPRC failover event on one or more storage devices based on one or more PPRC attention interrupts or a PPRC summary event unit check. The computing cluster recognizes that the failover event was not caused by the computing cluster and that a foreign computing cluster could be sharing HyperSwap managed devices with the computing cluster. In a particular embodiment, a Sense Subsystem Status I/O is used to detect that the failover occurred in reaction to an attention interrupt. In another particular embodiment, a Query Storage Controller Status I/O is used to detect that the failover occurred in reaction to a unit check for a PPRC summary event.

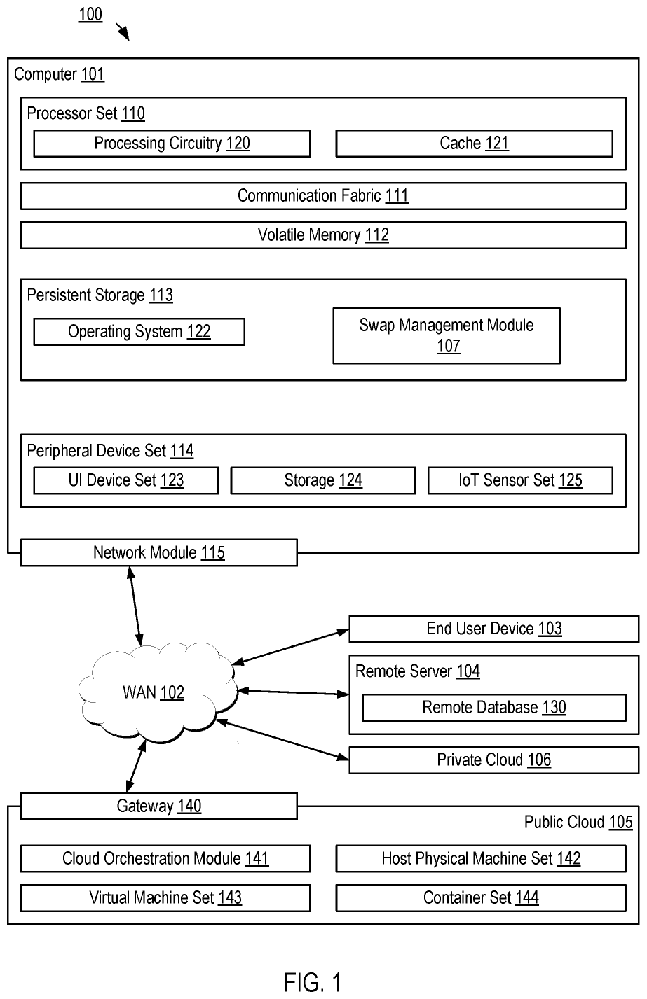

With reference now to FIG. 1, FIG. 1 sets forth an example computing environment according to aspects of the present disclosure. Computing environment 100 contains an example of an environment for the execution of at least some of the computer code involved in performing the various methods described herein, such as swap management module 107. In addition to swap management module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and swap management module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Such computer processors as well as graphic processors, accelerators, coprocessors, and the like are sometimes referred to herein as a processing device. A processing device and a memory operatively coupled to the processing device are sometimes referred to herein as an apparatus. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in swap management module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in swap management module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

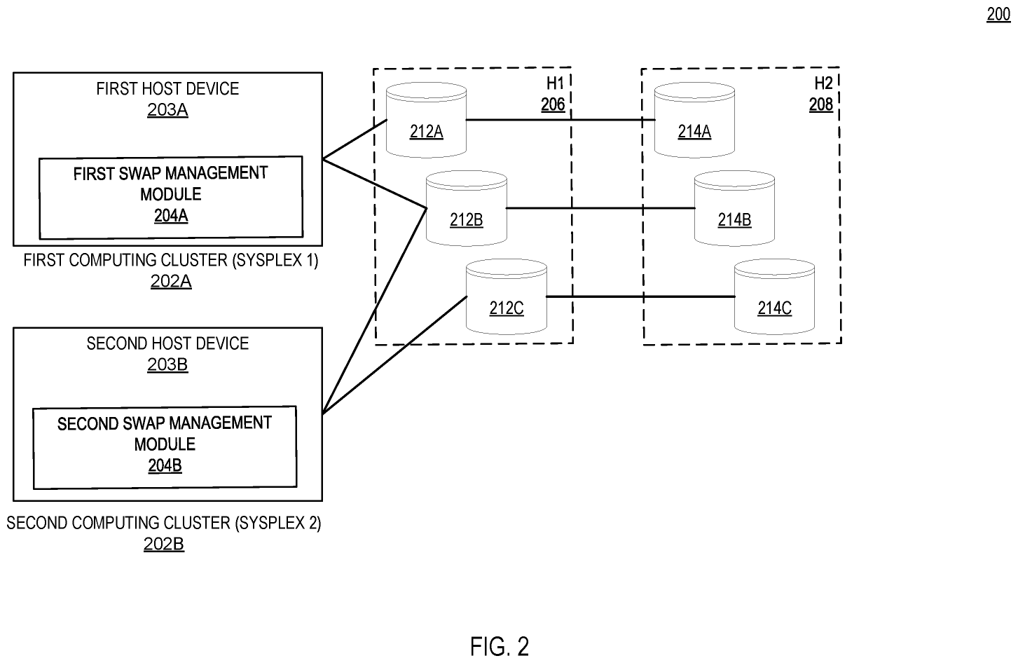

Referring now to FIG. 2, FIG. 2 sets forth another example computing environment according to aspects of the present disclosure. Computing environment 200 includes a first computing cluster (Sysplex 1) 202A having a first host device 203A and a second computing cluster (Sysplex 2) 202B having a second host device 203B. In a particular embodiment, the first host device 203A and the second host device 203B includes the computer 101 described with respect to FIG. 1. The first host device 203A includes a first swap management module 204A and the second host device 203B include a second swap management module 204B. In a particular embodiment, the first swap management module 204A and the second swap management module 204B includes the swap management module 107 described with respect to FIG. 1.

The first computing cluster 202A and the second computing cluster 202B are each in communication with a set of source storage devices (or volumes) (H1) 206. In a particular embodiment, each of first computing cluster 202A and the second computing cluster 202B are in communication with the set of source storage devices 206 via FICON connections. The set of source storage devices 206 are in communication with a set of target storage devices (or volumes) (H2) 208. In a particular embodiment, the set of source storage devices 206 are in communication with the set of target storage devices 208 via PPRC connections. In a particular embodiment, the set of source storage devices 206 and the set of target storage devices 208 are located at a different location or site. In one or more embodiments, each of the set of source storage devices 206 and the set of target storage devices 208 include one or more associated storage controllers (not shown). In one or more embodiments, the second computing cluster 202B is a foreign computing cluster in relation to the first computing cluster 202A.

The set of source storage devices 206 includes source storage devices 212A-212C in which source storage device 212A is a dedicated source storage device for the first computing cluster 202A, the source storage device 212C is a dedicated source storage device for the second computing cluster 202B, and the shared source storage device 212B is a shared source storage device by both the first computing cluster 202A and the second computing cluster 202B. The set of target storage devices 208 includes target storage devices 214A-214C in which target storage device 214A is a dedicated target storage device for the first computing cluster 202A, the target storage device 214C is a dedicated target storage device for the second computing cluster 202B, and the target storage device 214B is a shared target storage device by both the first computing cluster 202A and the second computing cluster 202B. Although various embodiments are illustrated using two computing clusters for simplicity of explanation, in other embodiments more than two computing clusters are used.

In an example operation, the first computing cluster 202A detects that a PPRC state change event has occurred on the source storage device 212B shared across the first computing cluster 202A and the second computing cluster 202B. The first computing cluster 202A determines that the PPRC state change event was not caused by the first computing cluster 202A and initiates a swap event to swap from usage of the source storage device 212B to usage of the target storage device 214B shared across the first computing cluster 202A and the second computing cluster 202B. In a particular embodiment, the PPRC state change event was caused by the second computing cluster 202B. In a particular embodiment, the PPRC state change event is a PPRC failover event.

In another example operation, the first computing cluster 202A determines that the PPRC state change event was not caused by the first computing cluster 202A includes determining that the source storage device 212B has transitioned from a secondary storage device status (e.g., a duplex secondary status) to a primary storage device status (e.g., suspended primary status), and determining that a PPRC remote copy operation associated with the source storage device 212B has been suspended. In another example operation, the first computing cluster 202A detects that the PPRC state change event has occurred by receiving an indication of a state change of the source storage device 212B. In another example operation, the first computing cluster 202A detects that the PPRC state change event has occurred by receiving a state change interrupt message indicative of a state change of the first storage device. In another example operation, the first computing cluster 202A detects that the PPRC state change event has occurred by receiving a unit check message indicative of a state change of the first storage device. In another example operation, the first computing cluster 202A initiates the swap event by sending an unplanned swap event notification signal.

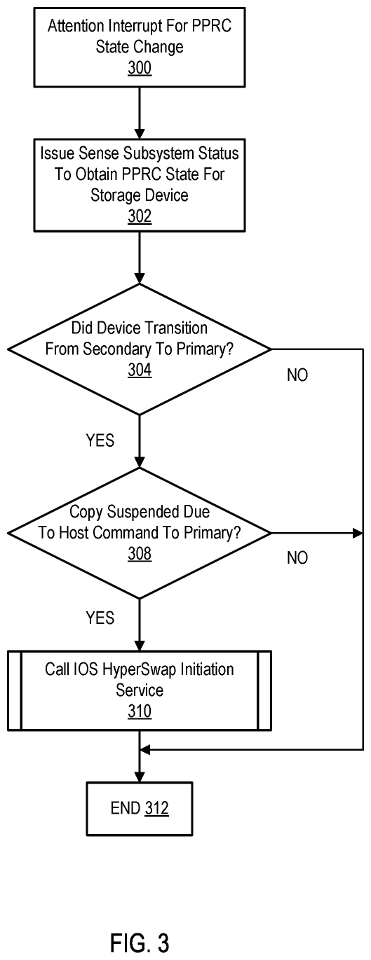

Referring now to FIG. 3, FIG. 3 sets forth a flowchart of an example process for state change interrupt processing according to aspects of the present disclosure. During an attention interrupt processing for PPRC state change 300, a first computing cluster (e.g., first computing cluster 202A) issues 302 a Sense Subsystem Status (SNSS) command to obtain a PPRC state for a first storage device shared by a number of computing clusters The SNSS command requests current state information associated with the first storage device including whether the first storage device is functioning as a primary or secondary storage device for swap functionality. The first computing cluster determines 304 whether the first storage device transitioned from a primary status to a secondary status based on the current state information. For example, the first storage device may have transitioned from primary status to a secondary status due to prior initiation of a HyperSwap operation by a second computing cluster (e.g., second computing cluster 202B). If the first storage device did not transition from secondary status to primary status, the example process ends 312.

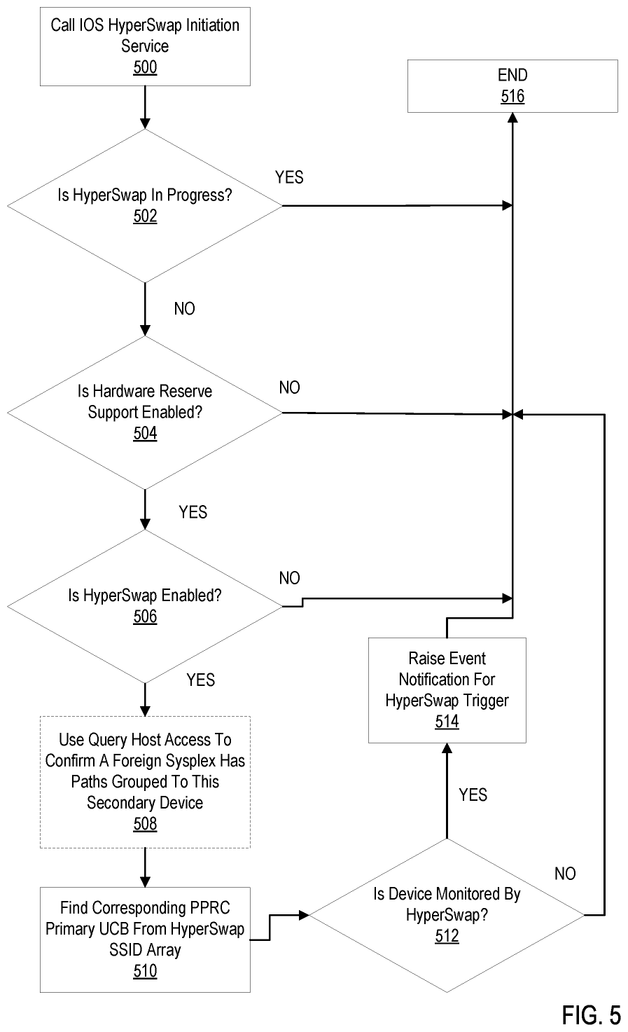

If the first storage device did transition from secondary status to primary status, the first computing cluster determines 308 whether a copy operation from the first storage device to a second storage device shared by the number of computing clusters has been suspended due to a host command being received by the primary storage device. If a copy operation was not suspended due to a host command being sent to the primary storage device, the example process ends 312. If a copy operation was suspended due to a host command being sent to the primary storage device, the first computing cluster calls 310 an IOS HyperSwap initiation service as further described with respect to FIG. 5 and the example process ends 312.

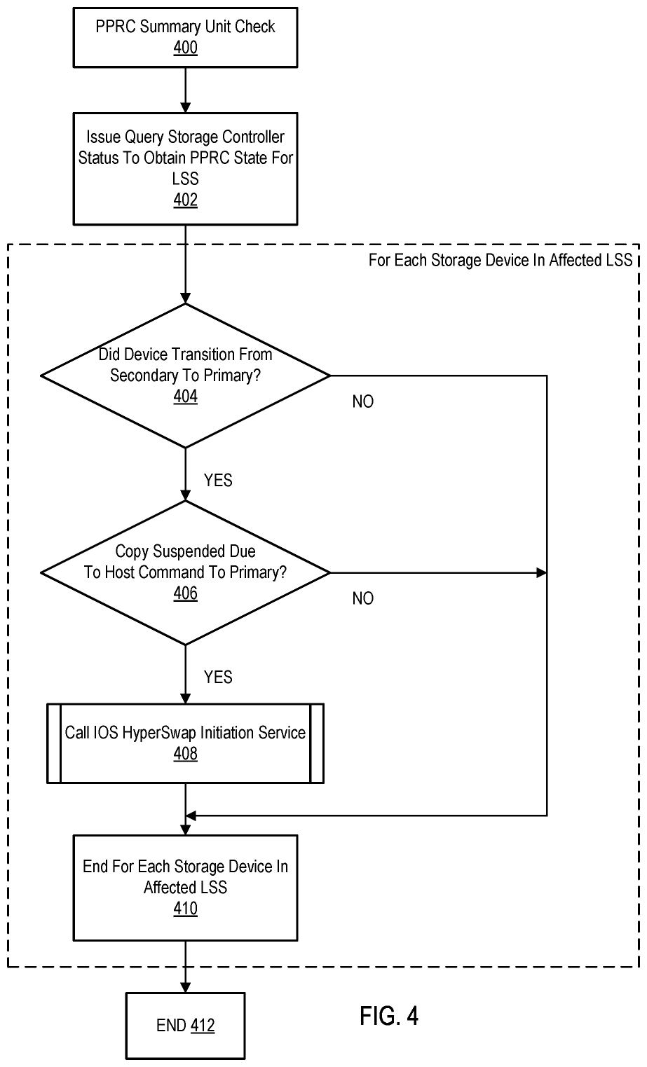

Referring now to FIG. 4, FIG. 4 sets forth a flowchart of an example process for peer-to-peer remote copy summary unit check processing according to aspects of the present disclosure. During a PPRC summary unit check processing operation 400, a first computing cluster (e.g., first computing cluster 202A) issues 402 a Query Storage Controller Status message to a storage controller for a number of storage devices in an LSS to obtain a PPRC state for every storage device within the LSS. For each storage device in the affected LSS, the first computing cluster determines 404 whether the first storage device transitioned from a primary status to a secondary status based on the current state information. For example, the first storage device may have transitioned from primary status to a secondary status due to prior initiation of a HyperSwap operation by a second computing cluster (e.g., second computing cluster 202B). If the first storage device did not transition from secondary status to primary status, the example process ends 410 for the current storage device.

If the first storage device transitioned from secondary status to primary status, the first computing cluster determines 406 whether a copy operation has been suspended due to a host command being received by the primary storage device. If a copy operation was not suspended due to a host command being sent to the primary storage device, the example process ends 410 for the current storage device. If a copy operation was suspended due to a host command being sent to the primary storage device, the first computing cluster calls 408 an IOS HyperSwap initiation service as further described with respect to FIG. 5 and the example process ends 410 for the current storage device in the affected LSS. Once all storage devices in the affected LSS have been evaluated, the example process ends 412.

Referring now to FIG. 5, FIG. 5 sets forth a flowchart of an example process for swap service initiation. During an IOS HyperSwap Initiation Service call 500, a first computing cluster (e.g., first computing cluster 202A) determines 502 whether a HyperSwap operation is already in progress. If a HyperSwap operation is already in progress, the example process ends 516. If a HyperSwap operation is not already in progress, the first computing cluster determines 504 whether hardware reserve support is enabled. Enablement of hardware reservice support ensures that active hardware reserves on primary PPRC devices are properly transferred to a new primary device after a HyperSwap operation. If hardware reserve support is not enabled, the example process ends 516. If hardware reserve support is enabled, the first computing cluster determines 506 if HyperSwap is enabled. If HyperSwap is not enabled, the example process ends 516.

If HyperSwap is enabled, the first computing cluster optionally uses 508 a query host access command to confirm a foreign sysplex has paths grouped to the secondary storage device to be swapped. The first computing cluster finds 510 the corresponding primary unit control block (UCB) from a HyperSwap subsystem identifier (SSID) array, and determines 512 if the storage device is monitored by HyperSwap. If the storage device is not monitored by HyperSwap, the example process ends 516. If the storage device is monitored by HyperSwap, the first computing cluster raises 514 and event notification for HyperSwap trigger to initiate a HyperSwap operation and the example process ends 516.

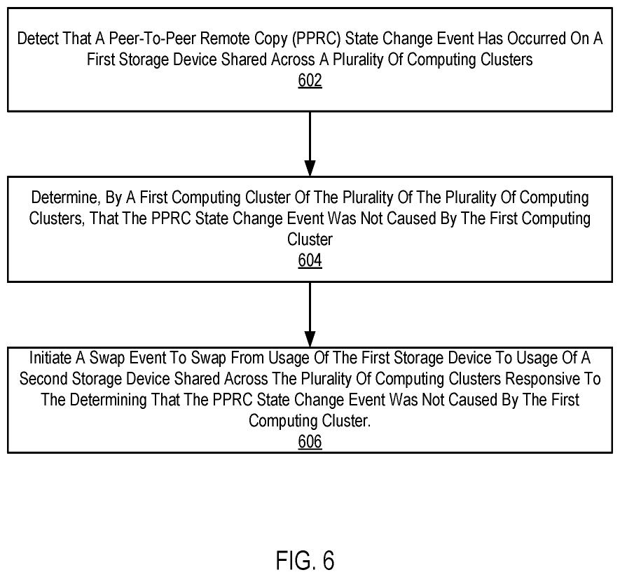

Referring now to FIG. 6, FIG. 6 sets forth a flowchart of an example process for storage device swap in a multiple computing cluster environment based on peer-to-peer remote copy state change according to aspects of the present disclosure. In the example process of FIG. 6, a first computing cluster detects 602 that a peer-to-peer remote copy (PPRC) state change event has occurred on a first storage device shared across a plurality of computing clusters. In a particular embodiment, the PPRC state change event is a PPRC failover event. In a particular embodiment, detecting that the PPRC state change event has occurred includes receiving an indication of a state change of the first storage device. In another particular embodiment, detecting that the PPRC state change event has occurred includes receiving a state change interrupt message indicative of a state change of the first storage device. In another particular embodiment, detecting that the PPRC state change event has occurred includes detecting that the PPRC state change event has occurred comprises receiving a unit check message indicative of a state change of the first storage device.

The first computing device determines 604 that the PPRC state change event was not caused by the first computing cluster. The first computing cluster initiates 606 a swap event to swap from usage of the first storage device to usage of a second storage device shared across the plurality of computing clusters responsive to the determining that the PPRC state change event was not caused by the first computing cluster. In a particular embodiment, initiating the swap event includes sending an unplanned swap event notification signal.

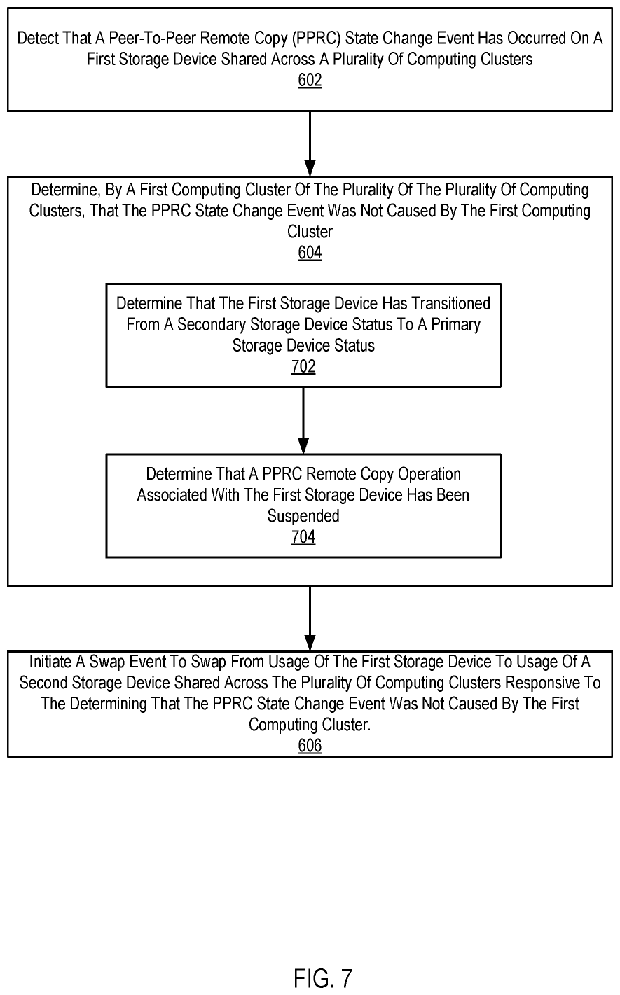

Referring now to FIG. 7, FIG. 7 sets forth a flowchart of another example process for storage device swap in a multiple computing cluster environment based on peer-to-peer remote copy state change according to aspects of the present disclosure. The process of FIG. 7 is similar to the process described with respect to FIG. 6 and further includes wherein determining 604 that the PPRC state change event was not caused by the first computing cluster includes determining 702 that the first storage device has transitioned from a secondary storage device status to a primary storage device status. In a particular embodiment, the secondary storage device status is a duplex secondary status. In another particular embodiment, the primary storage device status is a suspended primary status. Determining 604 that the PPRC state change event was not caused by the first computing cluster further includes determining 704 that a PPRC remote copy operation associated with the first storage device has been suspended.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting that a peer-to-peer remote copy (PPRC) state change event has occurred on a first storage device shared across a plurality of computing clusters;
determining, by a first computing cluster of the plurality of the plurality of computing clusters, that the PPRC state change event was not caused by the first computing cluster; and
initiating a swap event to swap from usage of the first storage device to usage of a second storage device shared across the plurality of computing clusters responsive to the determining that the PPRC state change event was not caused by the first computing cluster.

2. The method of claim 1, wherein the PPRC state change event comprises a PPRC failover event.

3. The method of claim 1, wherein determining that the PPRC state change event was not caused by the first computing cluster comprises:
determining that the first storage device has transitioned from a secondary storage device status to a primary storage device status; and
determining that a PPRC remote copy operation associated with the first storage device has been suspended.

4. The method of claim 3, wherein the secondary storage device status comprises a duplex secondary status.

5. The method of claim 3, wherein the primary storage device status comprises a suspended primary status.

6. The method of claim 1, wherein detecting that the PPRC state change event has occurred comprises receiving an indication of a state change of the first storage device.

7. The method of claim 1, wherein detecting that the PPRC state change event has occurred comprises receiving a state change interrupt message indicative of a state change of the first storage device.

8. The method of claim 1, wherein detecting that the PPRC state change event has occurred comprises receiving a unit check message indicative of a state change of the first storage device.

9. The method of claim 1, wherein initiating the swap event comprises sending an unplanned swap event notification signal.

10. An apparatus comprising:
a processing device; and
memory operatively coupled to the processing device, wherein the memory stores computer program instructions that, when executed, cause the processing device to:
detect that a peer-to-peer remote copy (PPRC) state change event has occurred on a first storage device shared across a plurality of computing clusters;
determine, by a first computing cluster of the plurality of the plurality of computing clusters, that the PPRC state change event was not caused by the first computing cluster; and
initiate a swap event to swap from usage of the first storage device to usage of a second storage device shared across the plurality of computing clusters responsive to the determining that the PPRC state change event was not caused by the first computing cluster.

11. The apparatus of claim 10, wherein the memory stores computer program instructions that, when executed, cause the processing device to determine that the PPRC state change event was not caused by the first computing cluster comprise computer program instructions to:
determine that the first storage device has transitioned from a secondary storage device status to a primary storage device status; and
determine that a PPRC remote copy operation associated with the first storage device has been suspended.

12. The apparatus of claim 11, wherein the secondary storage device status comprises a duplex secondary status.

13. The apparatus of claim 11, wherein the primary storage device status comprises a suspended primary status.

14. The apparatus of claim 10, wherein the memory stores computer program instructions that, when executed, cause the processing device to detect that the PPRC state change event has occurred comprise computer program instructions to receive an indication of a state change of the first storage device.

15. The apparatus of claim 10, wherein the memory stores computer program instructions that, when executed, cause the processing device to detect that the PPRC state change event has occurred comprise computer program instructions to receive a state change interrupt message indicative of a state change of the first storage device.

16. The apparatus of claim 10, wherein the memory stores computer program instructions that, when executed, cause the processing device to detect that the PPRC state change event has occurred comprise computer program instructions to receive a unit check message indicative of a state change of the first storage device.

17. A computer program product comprising a computer readable storage medium, wherein the computer readable storage medium comprises computer program instructions that, when executed:
detect that a peer-to-peer remote copy (PPRC) state change event has occurred on a first storage device shared across a plurality of computing clusters;
determine, by a first computing cluster of the plurality of the plurality of computing clusters, that the PPRC state change event was not caused by the first computing cluster; and
initiate a swap event to swap from usage of the first storage device to usage of a second storage device shared across the plurality of computing clusters responsive to the determining that the PPRC state change event was not caused by the first computing cluster.

18. The computer program product of claim 17, wherein the computer program instructions, when executed, determine that the PPRC state change event was not caused by the first computing cluster comprise computer program instructions to:
determine that the first storage device has transitioned from a secondary storage device status to a primary storage device status; and
determine that a PPRC remote copy operation associated with the first storage device has been suspended.

19. The computer program product of claim 17, wherein the computer program instructions that, when executed, detect that the PPRC state change event has occurred comprise computer program instructions to receive an indication of a state change of the first storage device.

20. The computer program product of claim 19, wherein the computer program instructions that, when executed, detect that the PPRC state change event has occurred comprise computer program instructions to receive a state change interrupt message indicative of a state change of the first storage device.
